(19) United States
(12) Patent Application Publication
(10) Pub. No.: US 2021/0344416 A1
(43) Pub. Date: Nov. 4, 2021

(54) Allocation of Downlink Carrier Power in LEO Communication Satellites

(71) Applicant: SATIXFY ISRAEL LTD., Rehovot (IL)

(72) Inventor: Arie KESHET, Ramat Gan (IL)

(21) Appl. No.: 17/273,092

(22) PCT Filed: Sep. 1, 2019
(86) PCT No.: PCT/IL2019/050979

§ 371 Date: Mar. 3, 2021

Related U.S. Application Data
(60) Provisional application No. 62/726,437, filed on Sep. 4, 2018.

(51) Int. Cl. H04B 7/185; H04B 7/204

(52) U.S. Cl. CPC H04B 7/18543; H04B 7/18526; H04B 7/204; H04B 7/18513

(57) ABSTRACT

A method is provided for simultaneously transmitting a plurality of signals from a LEO satellite towards a plurality of ground terminals located within a pre-defined range of distances from the LEO satellite, wherein the plurality of signals have a pre-defined overall capacity; at least two of the plurality of signals have each a power level that is different from a power level of the other of the at least two signals; and each signal transmitted to a respective ground terminal is selected so as to ensure that its power level is the lowest from among the signals that are simultaneously transmitted, yet the selected signal has a sufficient power to enable its proper reception at a distance which extends between the respective ground terminal and the LEO satellite.

### FIELD OF THE DISCLOSURE

The present disclosure relates to the field of communications and in particularly to communications exchanged in a satellite communications network.

### BACKGROUND

Communication satellites in Low Earth Orbit (LEO), circle the earth at a relatively low altitude from 500 to 1500 km. At these altitudes, the orbital period is in the order of 90 to 120 minutes and a satellite is only visible from any given location on the ground only for a small fraction of the time. Furthermore, because of its relatively low altitude, the satellite's field of view is limited to a few thousand km at the most. Due to both these reasons, a number of LEO satellites—a constellation—are needed in order to ensure provisioning of continuous communication coverage over a large area. In a typical constellation, several LEO satellites (e.g. 10) are placed at the same orbit at equal distances from each other. Additionally, similar groups of satellites (e.g. 12 in all) are placed each at a separate orbit, with the orbits being displaced from each other in order to provide optimal overall coverage. The constellation as a whole—120 satellites in this example—can provide continuous coverage of a large part of the globe by ensuring that at least one satellite is visible at all times from every location within the coverage area.

In order to increase their communications capacity and improve signal strength (“link budget”), LEO satellites use either multiple antennas or a multi-beam antenna array to illuminate their coverage area by multiple adjoining beams, each serving a ground cell. The RF bandwidth that is available to the satellite is re-used among beams in essentially the same way as done in cellular networks.

In order to optimize bandwidth and transmission power, the ground terminals that communicate with the satellite constellation are divided into two main categories:
a) User terminals that serve end-users such as a remote home or small business. Typically, they are small, large in number and are spread across the satellite's coverage area.
b) Gateways, on the other hand, are large terrestrial stations that connect the system to terrestrial networks and eventually to the Internet. They have large capacity and are few in number.

Separate sets of beams are used to connect each satellite to user terminals and gateways. Particularly, there is a small number (e.g. 3) of narrow gateway beams, each configured to illuminate one gateway.

LEO communication satellites can be distinguished over satellites which are designed to operate as a relay and those designed to operate as a switch. A relaying satellite receives signals from ground terminals and after processing the signals by performing filtering, frequency-conversion and amplification operations, transmitting the processed signals to the ground. A switching satellite, on the other hand, relies on a pre-agreed, packetized and addressed format of the ground signal to demodulate it and route each packet, based on its forwarding address, to one of its transmit beams, where it is modulated onto an appropriate channel for transmission to the ground. In a typical implementation, the relay satellite is designed as a “bent-pipe” or a “transparent” satellite, while a switching satellite is designed as a regenerative satellite equipped with on-board processing, demodulation, decoding, re-encoding and re-modulation capabilities.

A relaying satellite provides fixed, pre-configured connections between user beams and gateway beams. A switching satellite provides any-to-any connectivity, with each individual packet taking a path based on its own forwarding address.

Switching satellites are usually equipped with inter-satellite links (ISLs)—direct radio frequency (RF) or optical connections between adjacent satellites in the constellation. The ISLs form a part of the system's switching fabric so that a properly addressed packet may be received from the ground and be routed through multiple satellites before finally being transmitted back to the ground anywhere within the constellation's coverage area.

In case of a switching satellite, each individual user beam operates as a star—or hub-and-spokes—network, with the satellite acting as the network's hub. This network can use for example an air interface that complies with the DVB-RCS2 standard, enhanced to support LEO-system-specific requirements such as satellite tracking and handover. Gateway beams, on the other hand, are essentially one-to-one duplex connections: DVB-S2X is a common choice for implementing each half of this link.

Multi-beam satellites re-use the available spectrum among user beams at the same way as cellular networks. In a frequency division (FD) scheme, the spectrum is divided into N (typically four) parts, each of which is used in a sub-set of beams according to an N-color map pattern. Alternatively, with a time division (TD) or a beam hopping, the entire spectrum is used over (1/N)^{th} of the cells at a time, changing the illuminated cells in an N-dwell cyclic pattern that is the analog of the N-color map. One of the advantages of a beam hopping is the smaller number of receive and transmit chains it uses, leading to cost savings even when taking into consideration the larger bandwidth and higher power that a TD chain requires to keep overall capacity equal to that of an FD system. This advantage becomes even more significant for beams covering low-demand areas: there, the hopping cycle can be extended to more than N dwells, sharing capacity over a larger number of cells, or alternatively, allocate different dwell time for each cell, with none of the additional costs that FD would entail.

Beam-forming antenna arrays can be used to cost-effectively create a large number of narrow user beams, thus improving power efficiency and making it possible to use lower-size and therefore lower-cost user terminals. At the same time, the number of concurrent receive and transmit signals is still limited by power and other implementation constraints. Beam hopping may be used to bridge this gap by having the signals switched or hopped among a number of antenna beams in a pattern that matches the available capacity with the traffic demand in a cell covered by each beam dwell.

As explained above, for a typical LEO altitude of about 1000 km, the range extending from the satellite to a ground station located within its coverage area, varies from 1000 km when the ground station is located at the nadir, to—for the above example—2100 km, at the edge of the area covered by the satellite. Due to this substantial range variation, for a given power of a signal transmitted by the satellite to a terminal located at the edge of coverage area, that terminal will receive the signal at 6.5 dB less than the power at which a terminal located at the nadir will receive that signal. Equivalently, if one common signal (a modulated carrier) were used for communicating with all ground terminals associated with a given satellite, its power would need to be 6.5 dB higher than what might be otherwise, had it been directed only to terminals located at the nadir.

The term “nadir” as used herein is used to denote the direction pointing directly below the satellite.

### SUMMARY

The disclosure may be summarized by referring to the appended claims.

It is an object of the present disclosure to provide a solution that enables saving satellite transmit power without adversely affecting the system's performance.

It is another object of the present disclosure to provide a novel method for replacing a single signals having a pre-defined capacity which is strong enough to be received by all ground terminals comprised within the area covered by a satellite, transmitting a plurality of signals having the same overall pre-defined capacity as the single signal, wherein all ground terminals located within a certain range from the satellite, receive a signal from among the plurality of signals, at a sufficient power level to be properly received by these ground terminals.

Other objects of the present disclosure will become apparent from the following description.

Thus, according to a first aspect of the disclosure, there is provided a transmission method where its underlying principle is that instead of using a single signal which has a pre-defined capacity (measured, for example, in megabits per second), wherein that single signal is strong enough to be properly received by all terminals located within the satellite coverage area, the solution provided by the present disclosure is to use a plurality of signals having the same overall pre-defined capacity as the single signal, and wherein each of the plurality of signals has a power level that is sufficient to be properly received by ground terminals located within a certain range from the satellite (for example, up to 1200 km, up to 1400 km, etc.).

Transmission to a specific terminal is done by using the lowest power possible for transmission to that specific ground terminal (e.g. so that the power of a signal being transmitted is the power of a signal of a shortest distance that may be transmitted to the specific ground terminal, which can still be properly received thereat), thereby ensuring that communications are transmitted to all terminals while using the lowest power available for a signal transmitted to a respective terminal. In other words, the satellite continuously transmits a plurality of signals (modulated carriers) of different power. A transmission to a specific terminal is modulated onto one of these signals based on the signal's power, i.e. the signals are continuously transmitted and the method provided enables to choose from among the plurality of signals which one signal is used for transmission to which ground terminal.

From the point of view of their coverage area, LEO satellites are not stationary (unlike geosynchronous earth orbit—GEO—satellites). As a LEO satellite moves in its orbit, its distance to any given ground terminal changes. In other words, the satellite's nadir moves over the ground along with the satellite movement and together with this movement, the equal-distance concentric circles around it, move too, a fact that has an impact on the optimal power allocation.

Thus, according to a first embodiment of the disclosure, there is provided a method for simultaneously transmitting a plurality of signals from a LEO satellite towards a plurality of ground terminals located within a pre-defined range of distances from the LEO satellite, wherein:

a) the overall capacity of the plurality of signals has a pre-determined value;

b) at least two of the plurality of signals have each a power level that is different from a power level of the other of the at least two signals; and

c) each signal transmitted to a respective ground terminal is selected so as to ensure that its power level is lowest from among the signals that are simultaneously transmitted from the LEO satellite to the ground terminals, yet the selected signal has a sufficient power to enable proper reception thereof at a distance which extends between the respective ground terminal the said LEO satellite.

According to another embodiment, the LEO satellite's antenna is steered to illuminate a pre-defined, fixed area on the ground for a certain period of time, so that as the LEO satellite moves, the distances to different ground terminals located within the pre-defined range of distances from the LEO satellite, change in a non-uniform way while maintaining an optimal signals' power level.

By yet another embodiment, the optimal signal power is maintained by adopting a member of a group that consists of (i) modifying power of individual signals from among the plurality of signals; (ii) handing-over ground terminals by replacing a signal selected from among the plurality of ground terminals which is being transmitted to a specific ground terminal, with another signal selected from among that plurality of signals (in other words, at a certain point in time, the signal that is being used to communicate with a certain terminal, is replaced with another signal from among the plurality of signals); (iii) any applicable combination of (i) and (ii).

In accordance with still another embodiment, the LEO satellite's antenna is directed at a direction that is fixed relative to the nadir. In this case, the antenna beam sweeps across the ground and—from the point of view of the satellite—any given ground terminal that becomes subjected to the antenna beam, may be considered as a ground terminal that moves within the LEO satellite footprint relative to its center (or boresight) and eventually leaves it.

According to another embodiment, a power of a signal being transmitted from a certain LEO satellite towards a specific ground terminal, is modified during transmission of communications from that certain LEO satellite to the specific ground terminal.

By still another embodiment, the modification of the signal power and/or the handing over of a ground terminal between signals of the plurality of signals, is made by taking into consideration a change in distance between the LEO satellite and the specific ground terminal and/or a change in the antenna gain that occurred with respect to the ground terminal.

According to another embodiment, a LEO satellite's coverage area is divided into a plurality of cells and either: (i) each cell is covered by a separate beam used for transmission of a separate signal for communicating with ground terminals located within that respective cell; or (ii) each beam covers a number of cells by illuminating one cell at a time; or (iii) a combination of (i) and (ii).

In accordance with another embodiment, the method provided further comprising a step of allocating power to signals based on which beam is used for their transmission, while taking into consideration a distance that extends between the LEO satellite and a cell covered by each respective beam.

By yet another embodiment, the method further comprising using a beam-forming antenna array and applying an array element for combining the signals prior to their transmission.

According to still another embodiment, the method further comprising a step of allocating power to signals in accordance with their beam association while taking into consideration that when the beam-forming antenna array's boresight is directed at the center of the coverage area of the LEO satellite, beams that cover cells close to an edge of the LEO satellite coverage area will be received at a lower gain by respective ground terminals located within these cells that are close to an edge of the LEO satellite coverage area.

### BRIEF DESCRIPTION OF THE DRAWINGS

The accompanying drawing, which is incorporated herein and constitutes a part of this specification, illustrates an embodiment of the disclosure and, together with the description, serves to explain the principles of the embodiments disclosed herein.

FIG. 1—demonstrates a flow chart exemplifying a certain example construed in accordance with an embodiment of the present invention.

### DESCRIPTION OF EXEMPLARY EMBODIMENTS

Some of the specific details and values in the following detailed description refer to certain examples of the disclosure. However, this description is provided only by way of example and is not intended to limit the scope of the invention in any way. As will be appreciated by those skilled in the art, the claimed method and device may be implemented by using other methods that are known in the art per se. In addition, the described embodiments comprise different steps, not all of which are required in all embodiments of the invention. The scope of the invention can be summarized by referring to the appended claims.

The satellite communication network to which the present disclosure relates comprises a constellation of LEO satellites that circle the earth at a relatively low altitude. At these altitudes, the orbital period is in the order of 90 to 120 minutes and a satellite is only visible from any given location on the ground only for a small fraction of the time, and the satellite's field of view is limited to a few thousand km at the most.

Prior art satellite communication networks solutions, implement a method where signals are transmitted as single signals, each having a pre-defined capacity (measured, for example, in megabits per second) and which is strong enough to be properly received by all ground terminals located within the satellite coverage area.

In contradistinction to the prior art implementations of LEO satellites communication network referred to above, by the solution provided by the present disclosure, a plurality of signals replaces the single signal. This plurality of signals has the same overall pre-defined capacity as the single signal would have, and characterized in that each of the plurality of signals is transmitted to a respective ground terminal using the lowest power possible for such transmission to that specific ground terminal, yet it has a power level that is sufficient to be properly received by the respective ground terminal located within a certain range from the satellite (for example, up to 1200 km, up to 1400 km, etc.). In other words, the power of a signal being transmitted is the power of a signal of a shortest distance that may be transmitted to the specific ground terminal, which can still be properly received thereat, thereby ensuring that communications are transmitted to all terminals while using the lowest power available for a signal transmitted to a respective terminal. Thus, the satellite continuously transmits a plurality of signals (modulated carriers) at different power levels. A transmission to a specific terminal is modulated onto one of these signals based on the signal's power, i.e. the signals are continuously transmitted and the method provided enables to match which signal, from among the plurality of signals, will be used for transmission to each ground terminal.

From the point of view of their coverage area, LEO satellites are not stationary (unlike geosynchronous earth orbit—GEO—satellites). As a LEO satellite is moving in its orbit, its distance to any given ground terminal is changing. In other words, the satellite's nadir moves over the ground along with the satellite movement, and together with this movement, the equal-distance concentric circles around it, move too. To maintain an optimal power allocation, the above scheme may be implemented in either one of following two embodiments.

According to one embodiment, the method provided comprises a step of steering the satellite antenna to illuminate a pre-defined, fixed area on the ground for a certain period of time. As the satellite is moving, the distances to different ground terminals are changing in a non-uniform way and an optimal signal power is maintained.

In accordance with another embodiment, the optimal signal power is maintained by adopting one of the following options: (i) modifying the power of individual signals; (ii) “handing-over” ground terminals from one of the signals to another. In other words, at a certain point in time, the signal that is used to communicate with a certain ground terminal, is replaced with another signal; and (iii) any applicable combination of the above options (i) and (ii).

By one of the options that are possible to implement the method provided, the satellite antenna is directed at a direction that is fixed relative to the nadir. In this case, the antenna beam sweeps across the ground and—from the point of view of the satellite—any given terminal that enters the antenna beam, moves within its footprint relative to its center (or boresight) and eventually leaves it. According to this option, as the gain of the antenna towards a specific terminal changes with its relative position, the power of the signal received by the ground terminal, would be changed accordingly. When modifying the signal power and/or when handing over ground terminals from one signal to another, the variations due to distance and/or antenna gain may be taken into consideration when determining what should be the appropriate modification for signals transmitted to that ground terminal.

According to another option for the implementation of the solution provided herein, a LEO satellite's coverage area is divided into a plurality of cells, in order to enable increasing capacity through frequency re-use, as well as improving link conditions through higher antenna gain. Each of these cells may be covered by a different (separate) beam, or a “hopping beam” technique may be used, to enable covering a number of cells by cyclically directing the beam to each cell for a certain period of time.

Each beam may be used to transmit a separate signal for communicating with ground terminals located within the respective cell. In this case, the power of each beam's signal may be changed according to the average distance from the satellite to a respective cell, and this change of power may be implemented according to a pre-defined policy, as determined by the LEO satellite system operator. A possible policy may be one whose target is to reduce the overall satellite energy consumption, while another target may be set to increase the total transmission capacity, whereas another target may be provisioning of services to users in accordance with pre-defined individual service level agreements. Yet another target may be a combination of the above.

As in the single antenna case, the way that distances that extend from the satellite to the cells, and consequently the optimal power allocation, change along with the satellite movement, depends on whether the antennas creating the beams are fixed in orientation or are steered to illuminate a fixed area.

In accordance with another option of implementing the disclosure, a beam-forming antenna array is used rather than using separate antennas for generating a plurality of beams. When such an array is used instead of transmitting each signal by its own individual antenna, the signals are combined in any one of a number of ways that are known in the art per se, and each combination is transmitted by an array element. By controlling the way how signals are combined, a plurality of beams having desired directions and gains, may be generated by the array in a flexible and programmable way. When a beam-forming antenna array is used to generate a multi-beam coverage of a LEO satellite's service area, signals' combining can be modified to transmit, over each beam, at a signals' power level that is optimized for the distance to a cell which is illuminated by a respective beam from among the plurality of beams.

In certain implementations of beam-forming antenna arrays, the maximum beam gain that the antenna can generate falls off with the angle between the beam center and the array's boresight. If the beam-forming antenna array's boresight is directed at the center of the satellite's coverage area, beams that cover cells close to the edge of coverage will have a lower gain. Therefore, according to another embodiment of the present disclosure, the method provided further comprises a step of allocating power among beams' signals while taking into account the above factor, and wherein the allocation of power among the beams' signals is carried out according to a pre-determined power allocation policy.

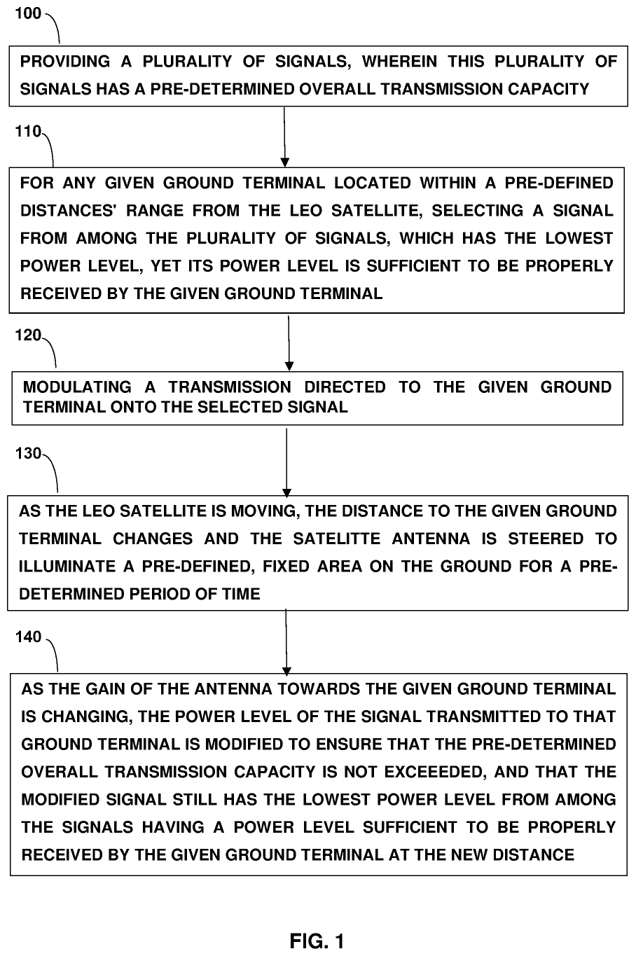

The flow chart depicted in FIG. 1, describes a certain example of implementing the solution provided by the present invention. Obviously, this is only one example from among the different options to implement the solution, some of which were described above.

In step 100a plurality of signals is provided, wherein the aggregated transmission capacity of all these signals has a pre-defined value. Next, at step 110, for any given ground terminal located within a pre-defined distance range from the LEO satellite, a signal is selected from among the plurality of signals. The selected signal has the lowest power level, yet its power level allows it to be properly received at the given ground terminal.

The communication that should be transmitted to the given ground terminal is modulated onto the selected signal (step 120).

As the LEO satellite is moving, the distance to the ground terminal changes and the satellite antenna is steered to illuminate a pre-defined, fixed area on the ground for a pre-determined period of time (step 130).

As the gain of the antenna toward the given ground terminal changes, the power level of the signal being transmitted is modified to ensure that the pre-defined overall transmission capacity is not exceeded, and that the modified signal still has the lowest power level from among the signals that have sufficient power level to be properly received at the ground terminal in its location relative to the new location of the satellite (step 140).

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method for simultaneously transmitting a plurality of signals from a LEO satellite towards a plurality of ground terminals located within a pre-defined range of distances from the LEO satellite, wherein:
a) said plurality of signals have a pre-defined overall capacity;
b) at least two of the plurality of signals have each a power level that is different from a power level of the other of the at least two signals; and
c) each signal transmitted to a respective ground terminal is selected so as to ensure that its power level is lowest from among the signals that are simultaneously transmitted from the LEO satellite to the ground terminals, yet the selected signal has a sufficient power to enable its proper reception at a distance which extends between said respective ground terminal and said LEO satellite.

2. The method of claim 1, wherein the LEO satellite's antenna is steered to illuminate a pre-defined, fixed area on the ground for a certain period of time, so that as the LEO satellite moves, the distances to different ground terminals located within the pre-defined range of distances from the LEO satellite, change in a non-uniform way while maintaining an optimal signals' power level.

3. The method of claim 2, wherein said optimal signal power is maintained by adopting a member of a group that consists of (i) modifying power of individual signals from among the plurality of signals; (ii) handing-over ground terminals by replacing a signal selected from among the plurality of ground terminals which is being transmitted to a specific ground terminal, with another signal selected from among that plurality of signals; (iii) any applicable combination of (i) and (ii).

4. The method of claim 1, wherein the LEO satellite's antenna is directed at a direction that is fixed relative to the nadir.

5. The method of claim 4, wherein a power of a signal being transmitted from a certain LEO satellite towards a specific ground terminal, is modified during transmission of communications from said certain LEO satellite to said specific ground terminal.

6. The method of claim 5, wherein said modification of the signal power is made by taking into consideration a change in distance between the LEO satellite and said specific ground terminal and/or a change in antenna gain that occurred with respect to said ground terminal.

7. The method of claim 1, wherein a LEO satellite's coverage area is divided into a plurality of cells and either: (i) each cell is covered by a separate beam used for transmission of a separate signal for communicating with ground terminals located within said respective cell; or (ii) each beam covers a number of cells by illuminating one cell at a time; or (iii) a combination of (i) and (ii).

8. The method of claim 7, further comprising a step of allocating power to signals based on which beam is used for their transmission, while taking into consideration a distance that extends between the LEO satellite and a cell covered by each respective beam.

9. The method of claim 7, further comprising using a beam-forming antenna array and combining the signals prior to their transmission by an array element.

10. The method of claim 9, further comprising a step of allocating power to signals in accordance with their beam association while taking into consideration that when said beam-forming antenna array's boresight is directed at the center of the coverage area of the LEO satellite, beams that cover cells close to an edge of the LEO satellite coverage area will be received at a lower gain by respective ground terminals located within said cells that are close to an edge of the LEO satellite coverage area.
